(19) United States
(12) Patent Application Publication
(10) Pub. No.: US 2026/0366128 A1
(43) Pub. Date: Nov. 19, 2026

(54) SYSTEM FOR COATING A METAL STRIP WITH A LAYER OF MOLTEN METAL

(71) Applicant: DANIELI & C. OFFICINE MECCANICHE S.P.A., Buttrio (IT)

(72) Inventors: Luciano VIGNOLO, Buttrio (IT); Antonello MORDEGLIA, Buttrio (IT); Gianfranco MARCONI, Buttrio (IT); Nicola GAGLIARDI, Buttrio (IT); Matteo Giacomo RICCI, Buttrio (IT)

(21) Appl. No.: 19/122,001

(22) PCT Filed: Oct. 25, 2023
(86) PCT No.: PCT/IB2023/060746

§ 371 Date: Apr. 17, 2025

(30) Foreign Application Priority Data
Oct. 25, 2022 (IT) 102022000021987

(51) Int. Cl. C23C 2/00; C21D 1/34; C23C 2/02; F24S 90/00

(52) U.S. Cl. CPC C23C 2/0038; C21D 1/34; C23C 2/0036; C23C 2/022; F24S 90/00

(57) ABSTRACT

A system for coating a metal strip with a layer of molten metal. The system comprises: a pot containing the molten metal bath; an annealing furnace arranged upstream of said pot for annealing a strip advancing towards said pot; at least one heating zone arranged upstream of said annealing furnace for preheating the metal strip, or in an intermediate position or end position of said annealing furnace for further heating said strip; a solar plant for recovering heat from solar radiation; at least one first conduit adapted to carry a first heat-transfer fluid to convey said heat from said solar plant towards the heating zone; and at least one heat exchanger cooperating with said at least one first conduit for recovering heat from said first heat-transfer fluid and heating the metal strip in said at least one heating zone.

### CROSS-REFERENCE TO RELATED APPLICATIONS

This application claims priority to PCT International Application No. PCT/IB2023/060746 filed on Oct. 25, 2023, which claims priority to Italian Patent Application No. 102022000021987 filed on Oct. 25, 2022, the entire disclosures of which are expressly incorporated herein by reference.

### STATEMENT RE: FEDERALLY SPONSORED RESEARCH/DEVELOPMENT

Not Applicable

### BACKGROUND

### 1. Field of the Invention

The present invention relates to the field of systems for coating flat bodies made of a ferromagnetic material, e.g., metal strips, in particular steel strips.

More specifically, the invention relates to a system and a related coating process, where there is provided a preheating of the strip upstream of the annealing furnace or a further heating of the strip in an intermediate or end zone of the annealing furnace.

### 2. Background Art

As known, strips made of a ferromagnetic material are externally coated through a plurality of coating processes, e.g., by zinc-coating.

The zone of the pot containing the molten metal bath, e.g., zinc, is the heart of the coating process and affects system operation, process productivity, product quality, and zinc consumption.

The cold-rolled strips or the hot-rolled and pickled strips are processed, in hot zinc-coating systems, in continuously operating heating and annealing furnaces.

Depending on the product, the quality of the incoming material and the expected quality of the outgoing material, the thermal heating cycle is defined by a maximum temperature of the material in the furnace, a temperature maintaining time, and a strip process speed.

Depending on the configuration, the annealing furnaces can be divided into horizontal, vertical or mixed furnaces, these latter with a horizontal and a vertical stretch.

The portion of the furnace dedicated to heating usually consists of modules of:
Pre-heating;
Open flame heating by means of burners;
Radiant tube heating by means of burners.
   The most commonly used technology is that using gaseous fossil fuels, mainly natural gas. Therefore, due to the combustion, the annealing furnace emits carbon dioxide into the atmosphere.

The great focus on reducing greenhouse gases, directly emitted by the combustion processes, leads to a reconsideration of the technology used for these operations.

Therefore, the need is felt for an innovative inspection of the hot coating systems, in order to reduce the direct emission of carbon dioxide into the atmosphere and potentially reduce the energy withdrawals from the public grid, which are in turn the cause of further indirect emissions.

### BRIEF SUMMARY

It is the object of the present invention to make a coating system for coating a metal strip with a layer of molten metal, which is capable of reducing emissions of carbon dioxide into the atmosphere by means of an efficient recovery of energy from the surrounding environment.

It is another object of the invention to carry out a related metal strip coating process with low environmental impact and high efficiency.

Therefore, the present invention aims to achieve the objects discussed above by making a metal strip coating system for coating a metal strip with a layer of molten metal, comprising
a pot containing the molten metal bath;
an annealing furnace, arranged upstream of said tank, for annealing a metal strip advancing towards said pot;
at least one heating zone, arranged upstream of said annealing furnace for preheating the metal strip and/or in an intermediate position and/or end position of said annealing furnace, for further heating said metal strip;
a solar plant for recovering heat from solar radiation by means of a first heat-transfer fluid;
at least one first conduit adapted to carry the first heat-transfer fluid to convey said heat from said solar plant towards the at least one heating zone;
at least one heat exchanger cooperating with said at least one first conduit for recovering heat from said first heat-transfer fluid and heating the metal strip in said at least one heating zone.

A further aspect of the invention is directed to a metal strip coating process, for coating a metal strip advancing along the aforesaid coating system, comprising the following stages:
annealing the metal strip in the annealing furnace,
coating the metal strip with a layer of molten metal by immersion in said pot;
   wherein there is provided a preheating of the metal strip in at least one heating zone, arranged upstream of said annealing furnace, and/or a further heating of the metal strip in at least one heating zone, arranged in an intermediate position or end position of said annealing furnace; where the first heat-transfer fluid conveys the heat recovered from said solar plant towards the at least one heating zone through the at least one first conduit;
   and wherein the at least one heat exchanger cooperating with said at least one first conduit recovers heat from said first heat-transfer fluid for carrying out said preheating or said further heating in the at least one heating zone.

Among the advantages of some embodiments of the invention there are:
high energy efficiency irrespective of the horizontal or vertical configuration of the annealing furnace;
the possibility of using autonomous and independent energy sources other than the public grid;
the possibility of having closed circuits for the recovery of the heat-transfer fluid, thus limiting the opex and discontinuities of the energy recovery system;
preheating the strip with autonomous sources allows further reducing the amount of energy needed to bring the strip to the convenient temperature for the hot coating, such as zinc-coating;
in general, the coating line has a low environmental impact as compared to the lines belonging to the prior art.

The dependent claims describe preferred embodiments of the invention.

### BRIEF DESCRIPTION OF THE FIGURES

Further features and advantages of the invention will become more apparent in the light of the detailed description of preferred, but not exclusive, embodiments of a coating system shown by way of a non-limiting example, with the aid of the accompanying drawings, in which:

FIG. 1 depicts a diagram of a first part of a first embodiment of a strip coating system according to the invention;

FIG. 2 depicts a diagram of a second part of the system in FIG. 1;

FIG. 3a depicts a diagram of a first variant of the second part of said first embodiment;

FIG. 3b depicts a diagram of a second variant of the second part of said first embodiment;

FIG. 4 depicts a diagram of a first part of a second embodiment of a strip coating system according to the invention;

FIG. 5 depicts a diagram of a variant of the first part of said second embodiment;

FIG. 6 depicts a diagram of a first part of a third embodiment of a strip coating system according to the invention;

FIG. 7 depicts possible different configurations of further components of the strip coating system according to the invention;

FIG. 8 depicts a diagram of the second part of a fourth embodiment of a strip coating system according to the invention;

FIG. 9 depicts some examples of inner channels in a roller of a heat exchanger of the system according to the invention.

The same reference numerals in the figures identify the same elements or components.

### DETAILED DESCRIPTION

With reference to the Figures, some exemplary embodiments of a system for coating a metal strip 20 with a molten metal layer according to the invention are depicted. As known, the metal strip is a product having a dimension, i.e., thickness, considerably smaller than the other two dimensions, i.e., length and width.

For example, the coating system can be a hot zinc-coating system for processing pickled or cold-rolled steel strips, such as:
strips made of low, medium or high carbon steel;
strips made of micro-alloyed steel;
strips made of Interstitial Free High Strength Steel (IFHSS);
strips made of Advanced High Strength Steel (AHSS).

In all embodiments of the invention, the coating system comprises:
a pot 2 containing the molten metal bath;
an annealing furnace 3, arranged upstream of the pot 2, for annealing a metal strip advancing towards the pot 2;
at least one heating zone 4, 4′, arranged upstream of the annealing furnace 3 for preheating the metal strip and/or in an intermediate position or end position of said annealing furnace 3 for further heating said metal strip;
a solar plant 5 for recovering heat from solar radiation by means of a first heat-transfer fluid;
at least one first conduit 6, 6′ adapted to carry the first heat-transfer fluid to convey the heat recovered from the solar plant 5 towards the at least one heating zone 4, 4′;
at least one heat exchanger 15, 7, 7′ cooperating with the at least one first conduit 6, 6′ for recovering heat from the first heat-transfer fluid and heating the metal strip in said at least one heating zone 4, 4′.

Preferably, for improved energy recovery efficiency, a solar concentration plant 5 is used, comprising:
a solar field 13 provided with a plurality of mirrors 14 for reflecting the solar radiation;
a first tank 10 for storing the first heat-transfer fluid at a low temperature;
a second tank 11 for storing the first heat-transfer fluid at a high temperature;
at least one tubing 12 for the first heat-transfer fluid connecting the first tank 10 to the second tank 11 by crossing the field 13.

The solar concentration plant 5 can comprise any plant which is an optimal compromise between surface installed, length, hours of storage, required power output, e.g., 5 MWt, and possible amount of loops of the at least one tubing 12.

By way of example, the solar concentration plant 5 can comprise a single loop to minimize the occupied surface, or up to four or more loops (known solutions, not shown).

In essence, two or more U-shaped intermediate stretches branch off from an initial stretch of the tubing 12 which starts from the first tank 10, crossing the solar field 13 above respective solar modules each comprising a plurality of mirrors 14, said intermediate stretches then converging into a final stretch of the tubing 12 which reaches the second tank 11.

The single loop can reach a length of about 350-700 meters, while the width is of about 40-50 meters, including peripheral maintenance routes of 3-4 meters.

Not having the desired length available, the loop could be broken up but adding, between one stretch and the other, internal maintenance routes which are 3-4 meters wide.

By increasing the loops, the hours of storage also increase.

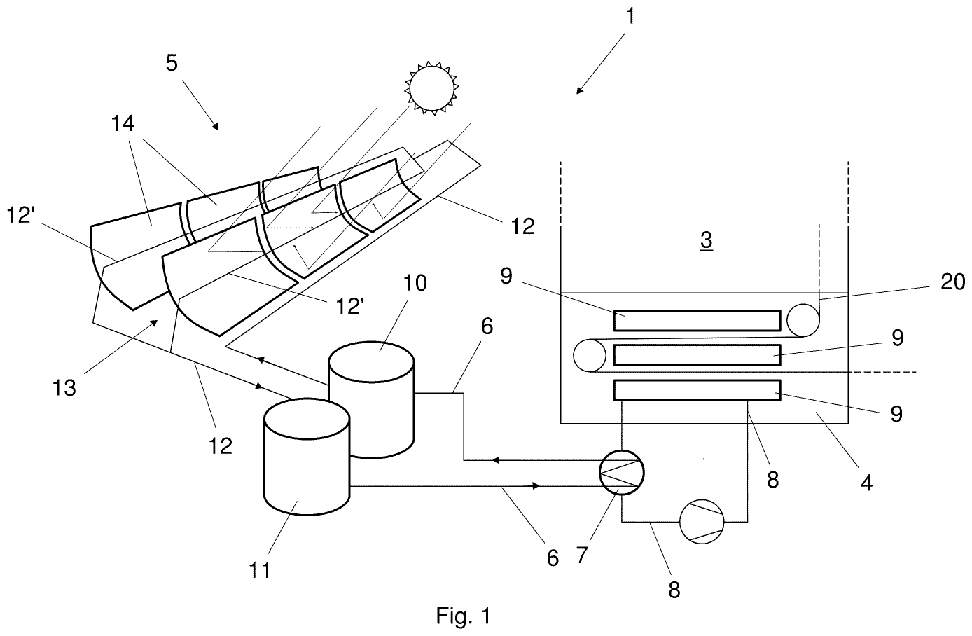

Instead, in the variant shown in FIG. 1, the tubing 12, which starts from the first tank 10, branches off into two or more branches 12′ crossing the solar field 13 above respective solar modules each comprising a plurality of mirrors 14, and then converging in a final stretch of the tubing 12 which reaches the second tank 11.

In all variants, the at least one tubing 12 can comprise, or consist of, a metal tube with an inner glass jacket and a vacuum condition in the middle, so as to reduce the dissipation of heat at night. Optionally, the mirrors 14 can be movable so as to reflect the solar radiation towards the at least one tubing 12, following the sunlight as times and seasons change.

The at least one first conduit 6 connects the second tank 11 to the first tank 10 by crossing the at least one heat exchanger 15, 7, 7′.

It is preferred that a first circuit comprising the first tank 10, the at least one tubing 12, and the second tank 11 is operable together with, or separately from, a second circuit comprising the second tank 11, the at least one first conduit 6, the at least one heat exchanger 15, 7, 7′, and the first tank 10. Indeed, actuation means are provided, such as pumps, for example, for actuating the first circuit and the second circuit together or separately.

It is thus possible to keep the operation of the solar plant 5 and the operation of the coating system of the invention mutually independent.

In order to minimize the region traveled by the first heat-transfer fluid in the second circuit, the second tank 11 can be positioned in proximity of both the at least one heat exchanger 15, 7, 7′ and the at least one heating zone 4, 4′.

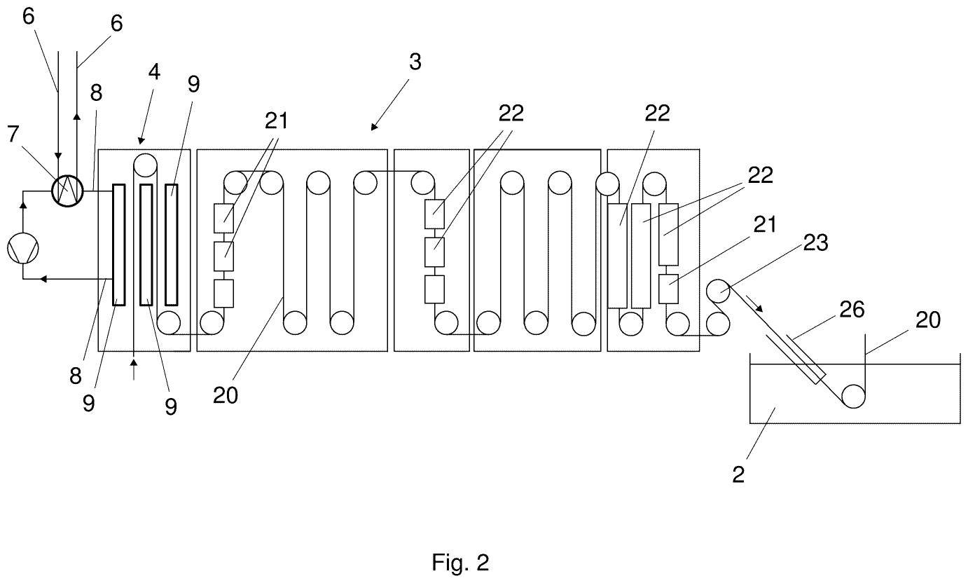

In FIGS. 2-3 and 8, the annealing furnace 3 shown is of the vertical configuration type, i.e., the metal strip 20 substantially advances along vertical stretches. The use of annealing furnaces with a horizontal configuration or of the mixed horizontal/vertical type is not excluded in the system of the invention.

In all embodiments of the coating system of the invention, the annealing furnace 3 comprises a plurality of modules crossed by the metal strip 20.

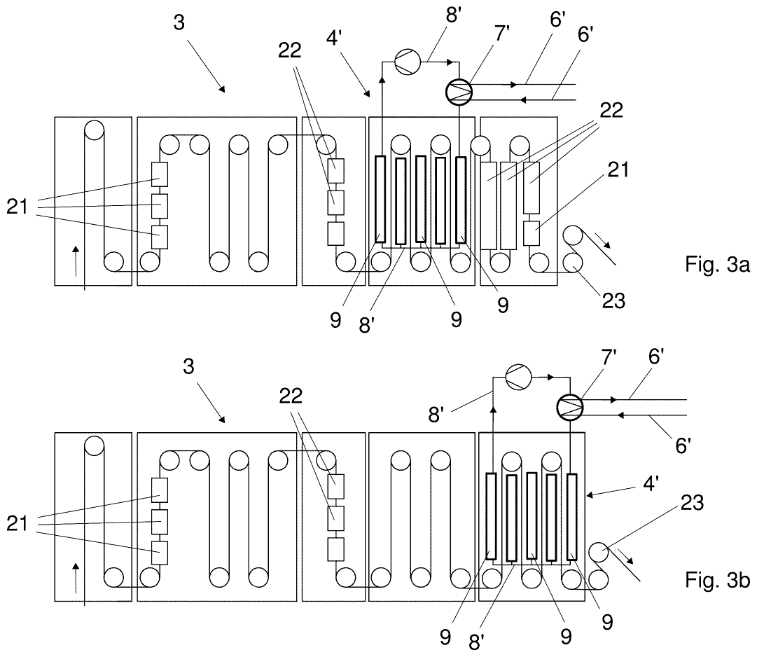

As shown by way of example in FIGS. 2-3b, some of these modules are provided with heating devices 21, such as open flame heating devices, radiant tube heating devices, induction heating devices, for example; other modules can be provided with cooling devices 22, such as reducing and/or inert gas spraying systems, for example; further modules can be provided both with heating devices 21 and cooling devices 22 along their respective stretch of the strip advancing path.

At the outlet of the annealing furnace 3 there are provided at least one bridle roller 23, which modifies the direction of the advancing path of the metal strip 20 exiting the annealing furnace 3 and which applies a tension to the strip, and a connection conduit 26 between said annealing furnace 3 and the pot 2.

In order to keep the first heat-transfer fluid at an optimal temperature of use, the first tank 10, the at least one tubing 12, the second tank 11 and the at least one first conduit 6, 6′ can have walls provided with temperature maintaining devices.

Preferably, the first heat-transfer fluid used in the present invention is part of the category of diathermic oils; however, in the case of using molten salts as the first heat-transfer fluid, such devices allow keeping the physical state of the salts liquid.

For example, said temperature maintaining devices comprise electrical resistors or inductors or tubes of water overheated by means of recovery heat.

In a first embodiment of the system of the invention, shown in FIGS. 1-3, at least one second conduit 8, 8′ is provided, adapted to carry a second heat-transfer fluid and crossing the at least one heating zone 4, 4′.

In this case, the at least one heat exchanger 7, 7′ cooperates with the at least one first conduit 6, 6′ and the at least one second conduit 8, 8′ so that the second heat-transfer fluid is heated by recovering heat from the first heat-transfer fluid.

Advantageously, at least one dispensing device 9 is provided, arranged inside the at least one heating zone 4, 4′, connected to the at least one second conduit 8, 8′ and adapted to dispense the second heat-transfer fluid towards at least one passage area of the metal strip 20 into said at least one heating zone 4, 4′ for heating the metal strip by convection.

The at least one first conduit 6, 6′ connects the second tank 11 to the first tank 10 by crossing the at least one heat exchanger 7, 7′.

The at least one second conduit 8, 8′ is part of a closed circuit, which also includes the passage in the heat exchanger 7, 7′ and in the at least one dispensing device 9.

Preferably, the at least one heat exchanger 7, 7′ is arranged outside the heating zone 4, 4′, even more preferably positioned above the second tank 11 so as to drain it by gravity.

In this case, the structure comprising the second tank 11 and the heat exchanger 7, 7′ should not exceed a height of 25 meters.

Optionally, the dispensing devices 9 are arranged on both sides of the stretches of the flat advancing path of the metal strip 20 between one return roller, or bridle roller, and the next.

Such dispensing devices 9 can comprise tubular elements provided with a plurality of nozzles facing the strip advancing path. In the non-limiting embodiment of the Figures, three or more dispensing devices 9 are provided.

In a first variant of said first embodiment of the system of the invention, shown in FIGS. 1 and 2, there are provided:
a single heating zone 4 arranged upstream of the annealing furnace 3 for preheating the metal strip;
a first conduit 6 to carry the first heat-transfer fluid, conveying the heat recovered by means of the solar plant 5 from the second tank 11 to the heating zone 4 and then to the first tank 10;
a second conduit 8 to carry the second heat-transfer fluid through the heating zone 4;
a single heat exchanger 7 cooperating with the first conduit 6 and the second conduit 8 so that the second heat-transfer fluid is heated by recovering heat from the first heat-transfer fluid.

The first conduit 6 connects the second tank 11 to the first tank 10 by crossing the heat exchanger 7.

In a second variant of said first embodiment of the system of the invention, shown in FIG. 3a, there are provided:
a single heating zone 4′ arranged in an intermediate position of the annealing furnace 3 for further heating the metal strip;
a first conduit 6′ to carry the first heat-transfer fluid, conveying the heat recovered by means of the solar plant 5, from the second tank 11 to the heating zone 4′ and then to the first tank 10;
a second conduit 8′ to carry the second heat-transfer fluid through the heating zone 4′;
a single heat exchanger 7′ cooperating with the first conduit 6′ and the second conduit 8′ so that the second heat-transfer fluid is heated by recovering heat from the first heat-transfer fluid.

The first conduit 6′ connects the second tank 11 to the first tank 10 by crossing the heat exchanger 7′.

In a third variant of said first embodiment of the system of the invention, shown in FIG. 3b, there are provided:
a single heating zone 4′ arranged in an end position, e.g., a final position, of the annealing furnace 3 for further heating the metal strip before sending to the pot 2, for example to compensate for any temperature drops which could bring the material to a temperature lower than the temperature of the molten metal bath;
a first conduit 6′ to carry the first heat-transfer fluid, conveying the heat recovered by means of the solar plant 5, from the second tank 11 to the heating zone 4′ and then to the first tank 10;
a second conduit 8′ to carry the second heat-transfer fluid through the heating zone 4′;
a single heat exchanger 7′ cooperating with the first conduit 6′ and the second conduit 8′ so that the second heat-transfer fluid is heated by recovering heat from the first heat-transfer fluid. The first conduit 6′ connects the second tank 11 to the first tank 10 by crossing the heat exchanger 7′.

In a fourth variant of said first embodiment of the system of the invention, not shown but corresponding to a combination of the solutions of FIGS. 2 and 3a or of FIGS. 2 and 3b, there are provided:
a first heating zone 4 arranged upstream of the annealing furnace 3 for preheating the metal strip;
a first conduit 6 to carry the first heat-transfer fluid, conveying the heat recovered by means of the solar plant 5, from the second tank 11 to the first heating zone 4 and then to the first tank 10;
a second conduit 8 to carry the second heat-transfer fluid through the first heating zone 4;
a first heat exchanger 7 cooperating with the first conduit 6 and the second conduit 8 so that the second heat-transfer fluid is heated by recovering heat from the first heat-transfer fluid;
a second heating zone 4′ arranged in an intermediate position or end position, e.g., a final position, of the annealing furnace 3 for further heating the metal strip;
a further first conduit 6′ to carry the first heat-transfer fluid, conveying the heat recovered by means of the solar plant 5, from the second tank 11 to the second heating zone 4′ and then to the first tank 10;
a further second conduit 8′ to carry the second heat-transfer fluid through the second heating zone 4′;
a second heat exchanger 7′ cooperating with the further first conduit 6′ and with the further second conduit 8′ so that the second heat-transfer fluid is heated by recovering heat from the first heat-transfer fluid.

The first conduit 6 connects the second tank 11 to the first tank 10 by crossing the first heat exchanger 7.

The further first conduit 6′ connects the second tank 11 to the first tank 10 by crossing the second heat exchanger 7′.

The possible provision of a further variant of said first embodiment, corresponding to a combination of the solutions in FIGS. 2, 3a and 3b, is not excluded.

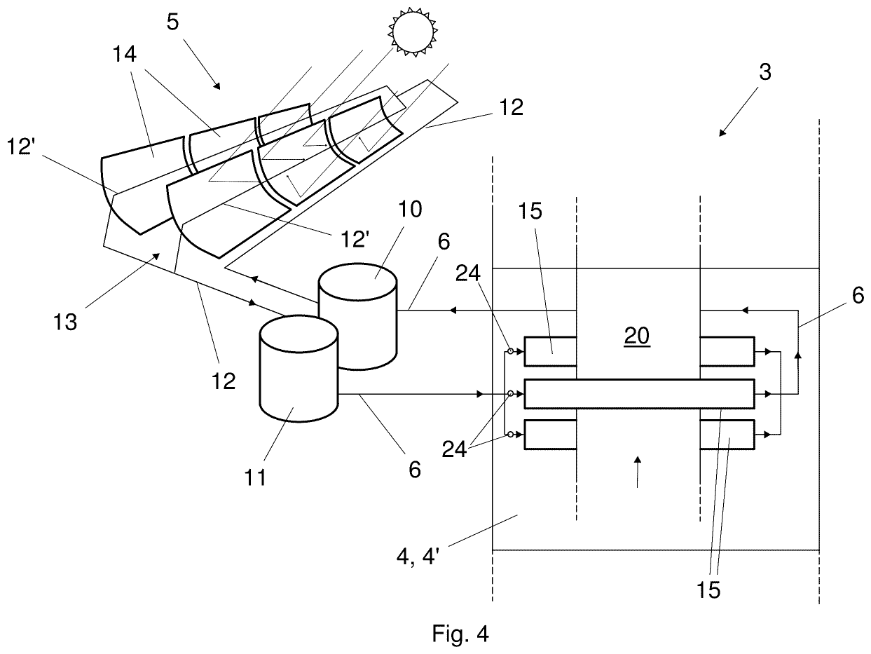

In a second embodiment of the system of the invention, shown in FIGS. 4-7, the at least one heat exchanger comprises, or consists of, a plurality of rollers 15, e.g., bridle rollers, arranged inside the at least one heating zone 4, 4′ for advancing the metal strip 20 and cooperating directly or indirectly with the at least one first conduit 6, 6′.

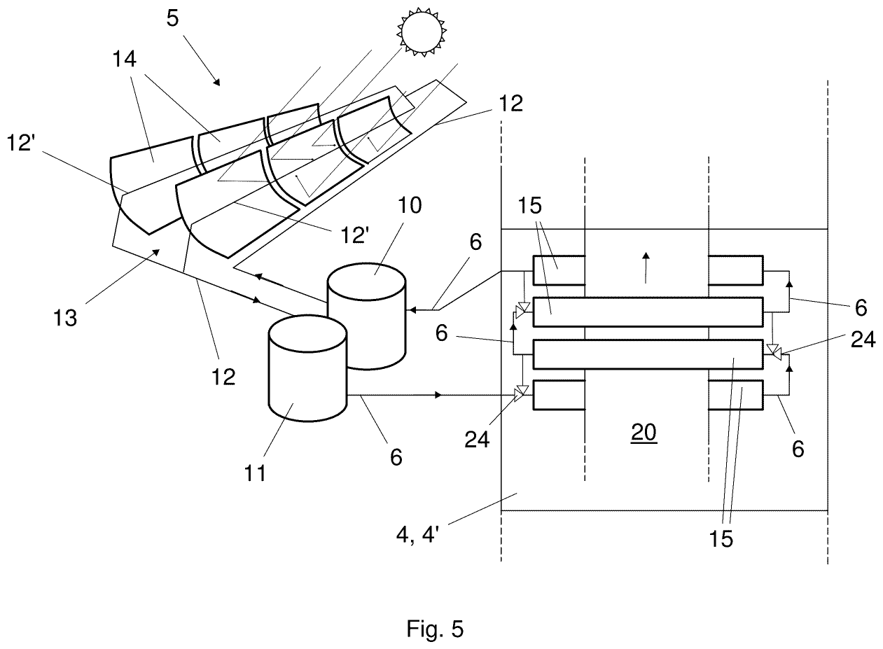

In a first variant of said second embodiment of the system of the invention, shown in FIGS. 4-5, said rollers 15 are provided with at least one inner channel formed so that the rollers 15 can be crossed by the first heat-transfer fluid for heating the metal strip by conduction, the rollers 15 being in direct contact with the strip. In this case, the at least one first conduit 6, 6′ crosses the at least one heating zone 4, 4′.

Preferably, the rollers 15 are interposed between an initial stretch and a final stretch of the at least one first conduit 6, 6′ and the respective at least one inner channel communicates with the at least one first conduit 6, 6′ so as to be crossed by the first heat-transfer fluid and heat the metal strip by conduction.

The inner channels of the rollers 15 are connected in parallel, as in the example in FIG. 4, and communicating at the ends with the initial stretch and the final stretch of the at least one first conduit 6, 6′; or said inner channels of the rollers 15 are connected in series, as in the example in FIG. 5, by means of intermediate stretches of the at least one first conduit 6, 6′.

It is possible to arrange a series of valves 24, e.g., by-pass valves, to avoid supplying one or more inner channels if it is necessary to decrease the heat exchange, e.g., as a function of the thickness of the product to be annealed.

The inner channels of the rollers 15, preferably through inner channels, can define a rectilinear axis, substantially parallel to the longitudinal axis of the respective roller 15, or a helical or spiral axis, which is wound inside the longitudinal axis of the respective roller 15.

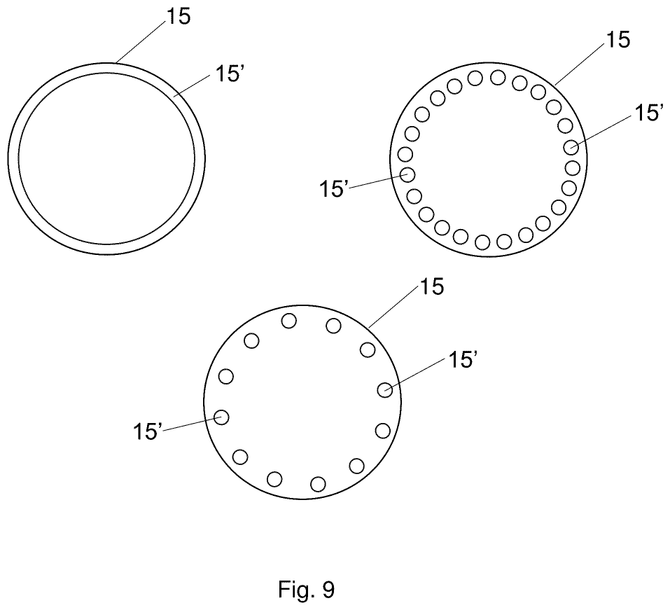

Only one inner channel 15′, or inner jacket, can be present inside each roller 15, which can be annular or non-annular in shape, for example; or several inner channels or inner cavities 15′ can be present, possibly communicating with one another. Some non-limiting examples of inner channels 15′ can be seen in the cross-sections of a roller 15, shown in FIG. 9. The inner channels can have any cross-section shape, not only round. For example, the cross-section can be polygonal.

The at least one first conduit 6, 6′ connects the second tank 11 to the first tank 10 by cooperating with the at least one inner channel of the rollers 15.

A first circuit comprises the first tank 10, the at least one tubing 12, and the second tank 11; and a second circuit comprises the second tank 11, the at least one first conduit 6, 6′, the inner channels of the rollers 15, and the first tank 10; said first circuit and said second circuit being operable together or separately. Indeed, actuation means are provided, such as pumps, for example, for actuating the first circuit and the second circuit together or separately.

In a first example of the second embodiment, there are provided:
a single heating zone 4, 4′, arranged upstream of the annealing furnace 3 for preheating the metal strip, or in an intermediate position or end position, e.g., a final position, of the annealing furnace 3;
and a first conduit 6 to carry the first heat-transfer fluid, conveying the heat recovered by means of the solar plant 5, from the second tank 11 to the heating zone 4, 4′ cooperating with the inner channels of the rollers 15, and then to the first tank 10.

The first conduit 6 connects the second tank 11 to the first tank 10 by cooperating with the inner channels of the plurality of the rollers 15.

In FIGS. 4 and 5, the heating zone 4, 4′ can be an initial, intermediate or final zone of the annealing furnace 3, along the advancing direction of the strip 20.

In a second example (not shown) of the second embodiment, there are provided:
a first heating zone 4 arranged upstream of the annealing furnace 3 for preheating the metal strip;
a first conduit 6 to carry the first heat-transfer fluid conveying the heat recovered by means of the solar plant 5 from the second tank 11 to the first heating zone 4 and then to the first tank 10;
a first group of rollers 15 cooperating with the first conduit 6 so that the metal strip 20 is heated by conduction recovering heat from the first heat-transfer fluid;
a second heating zone 4′ arranged in an intermediate position or end position, e.g., a final position, of the annealing furnace 3 for further heating the metal strip;
a further first conduit 6′ to carry the first heat-transfer fluid, conveying the heat recovered by means of the solar plant 5, from the second tank 11 to the second heating zone 4′ and then to the first tank 10;
a second group of rollers 15 cooperating with the further first conduit 6′ so that the metal strip 20 is further heated by conduction recovering heat from the first heat-transfer fluid.

The first conduit 6 connects the second tank 11 to the first tank 10 by cooperating with the inner channels of the first group of rollers 15.

The further first conduit 6′ connects the second tank 11 to the first tank 10 by cooperating with the inner channels of the second group of rollers 15.

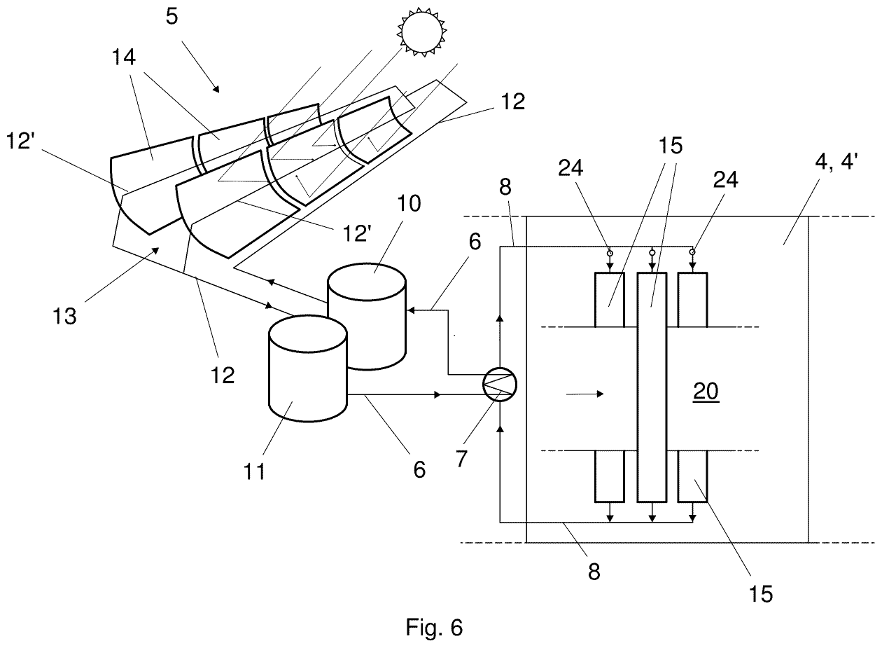

In a second variant of said second embodiment of the system of the invention, shown in FIG. 6, there are advantageously provided:
at least one second conduit 8, 8′ adapted to carry a second heat-transfer fluid and crossing the at least one heating zone 4, 4′;
and a further heat exchanger 7, 7′, arranged outside the heating zone and cooperating with the at least one first conduit 6, 6′ and the at least one second conduit 8, 8′ so that the second heat-transfer fluid is heated by recovering heat from the first heat-transfer fluid.

Each of the rollers 15 is provided with at least one inner channel, formed so that the rollers 15 can be crossed by the second heat-transfer fluid for heating the metal strip by conduction.

Preferably, the rollers 15 are interposed between a first stretch and a second stretch of the at least one second conduit 8, 8′ and the respective at least one inner channel of the rollers 15 communicates with the first stretch and the second stretch so as to be crossed by the second heat-transfer fluid for heating the metal strip by conduction, the rollers 15 being in direct contact with the strip.

The further heat exchanger 7, 7′ can be arranged between the first stretch and the second stretch of said at least one second conduit 8, 8′.

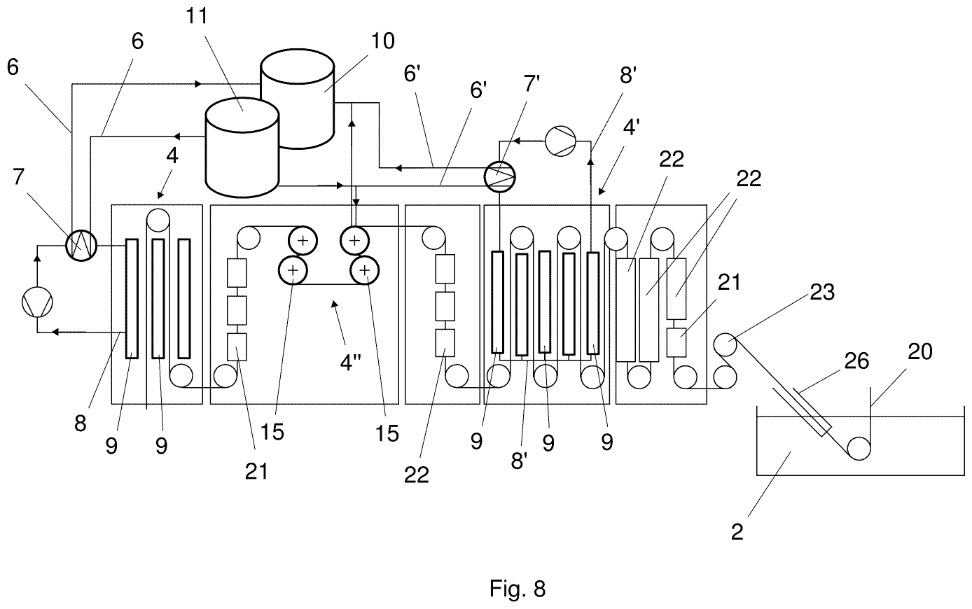

In this second variant of the second embodiment, the inner channels of the rollers 15 are connected in parallel, as in the example in FIG. 8, and communicating at the ends with the first stretch and the second stretch of the at least one second conduit 8, 8′; or said inner channels of the rollers 15 are connected in series (not shown solution) by means of intermediate stretches of the at least one second conduit 8, 8′.

It is possible to arrange a series of valves 24, e.g., by-pass valves, to avoid supplying one or more inner channels if it is necessary to decrease the heat exchange, e.g., as a function of the thickness of the product to be annealed.

The inner channels of the rollers 15, preferably through inner channels, can define a rectilinear axis, substantially parallel to the longitudinal axis of the respective roller 15, or a helical or spiral axis, which is wound inside the longitudinal axis of the respective roller 15.

Only one inner channel 15′, or inner jacket, can be present inside each roller 15, which can be annular or non-annular in shape, for example; or several inner channels or inner cavities 15′ can be present, possibly communicating with one another. Some non-limiting examples of inner channels 15′ can be seen in the cross-sections of a roller 15, shown in FIG. 9. The inner channels can have any cross-section shape, not only round. For example, the cross-section can be polygonal.

The at least one first conduit 6, 6′ connects the second tank 11 to the first tank 10 by crossing the further heat exchanger 7, 7′.

A first circuit comprises the first tank 10, the at least one tubing 12, and the second tank 11; and a second circuit comprises the second tank 11, the at least one first conduit 6, 6′, the at least one further heat exchanger 7, 7′, and the first tank 10; said first circuit and said second circuit being operable together or separately. Indeed, actuation means are provided, such as pumps, for example, for actuating the first circuit and the second circuit together or separately.

In a first variant of the third embodiment, there are provided:
a single heating zone 4, 4′, arranged upstream of the annealing furnace 3 for preheating the metal strip, or in an intermediate position or end position, e.g., a final position, of the annealing furnace 3;
a first conduit 6 to carry the first heat-transfer fluid, conveying the heat recovered by means of the solar plant 5, from the second tank 11 to the heating zone 4, 4′ and then to the first tank 10;
a second conduit 8 to carry the second heat-transfer fluid through the heating zone 4, 4′ cooperating with the inner channels of the rollers 15;
a further heat exchanger 7, arranged outside the heating zone and cooperating with the first conduit 6 and the second conduit 8 so that the second heat-transfer fluid is heated by recovering heat from the first heat-transfer fluid.

The first conduit 6 connects the second tank 11 to the first tank 10 by crossing the heat exchanger 7.

The second conduit 8 is part of a closed circuit including the passage in the heat exchanger 7 and the inner channels of the rollers 15.

In FIG. 6, the heating zone 4, 4′ can be an initial, intermediate or final zone of the annealing furnace 3, along the advancing direction of the strip 20.

In a second variant (not shown) of the third embodiment, there are provided:
a first heating zone 4 arranged upstream of the annealing furnace 3 for preheating the metal strip;
a first conduit 6 to carry the first heat-transfer fluid, conveying the heat recovered by means of the solar plant 5, from the second tank 11 to the first heating zone 4 and then to the first tank 10;
a second conduit 8 to carry the second heat-transfer fluid through the first heating zone 4;
a first further heat exchanger 7, arranged outside the first heating zone and cooperating with the first conduit 6 and the second conduit 8 so that the second heat-transfer fluid is heated by recovering heat from the first heat-transfer fluid;
a first group of rollers 15 cooperating with the second conduit 8 so that the metal strip 20 is heated by conduction recovering heat from the first heat-transfer fluid;
a second heating zone 4′ arranged in an intermediate position or end position, e.g., a final position, of the annealing furnace 3 for further heating the metal strip;
a further first conduit 6′ to carry the first heat-transfer fluid, conveying the heat recovered by means of the solar plant 5, from the second tank 11 to the second heating zone 4′ and then to the first tank 10;
a further second conduit 8′ to carry the second heat-transfer fluid through the second heating zone 4′;
a second further heat exchanger 7′, arranged outside the first heating zone and cooperating with the further first conduit 6′ and the further second conduit 8′ so that the second heat-transfer fluid is heated by recovering heat from the first heat-transfer fluid;
a second group of rollers 15 cooperating with the further second conduit 8′ so that the metal strip 20 is further heated by conduction recovering heat from the first heat-transfer fluid.

The first conduit 6 connects the second tank 11 to the first tank 10 by cooperating with the first further heat exchanger 7.

The further first conduit 6′ connects the second tank 11 to the first tank 10 by cooperating with the second further heat exchanger 7′.

The second conduit 8 is part of a closed circuit including the passage in the first further heat exchanger 7 and the inner channels of the first group of rollers 15.

The further second conduit 8 is part of a further closed circuit including the passage in the second further heat exchanger 7 and the inner channels of the second group of rollers 15.

In both the second and third embodiments of the invention, the rollers 15 are made of a material with a high heat-exchange coefficient and are crossed by a heat-transfer fluid for transferring heat to the metal strip 20.

The number of rollers 15 in each heating zone varies, for example from 3 to 8. However, it is also possible to make groups of rollers 15 exceeding 8 in number.

The rollers 15 can have a diameter between 1 and 2 meters, with inlet and outlet of the heat-transfer fluid in/from the inner channels of the roller through the hubs of the roller itself.

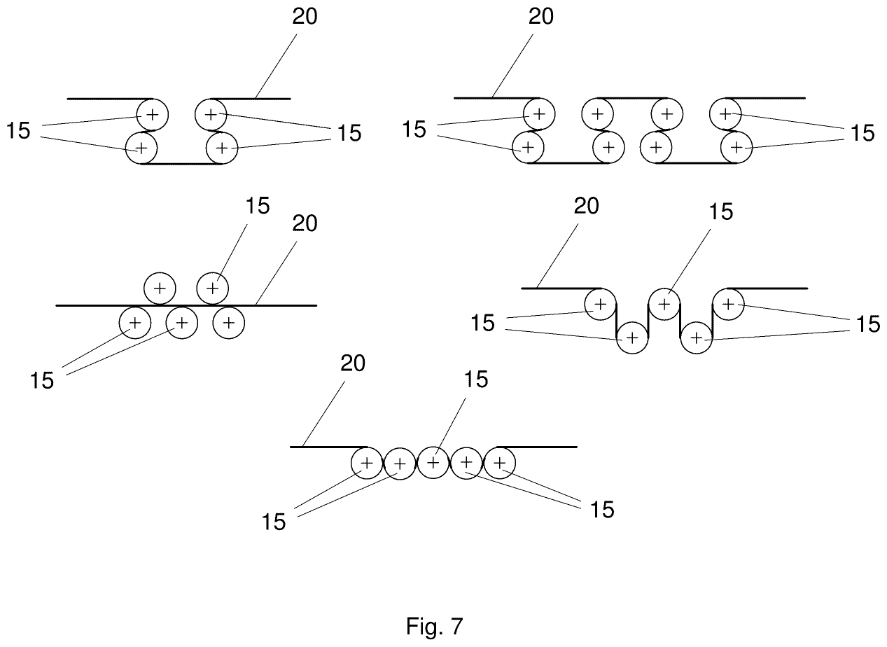

FIG. 7 shows some configuration examples of the rollers 15 inside a heating zone 4, 4′. It is possible to understand how the heat exchange capacity is a function of the contact surface between strip 20 and rollers 15: the best results are obtained in configurations in which the roller 15 is wound by the strip over at least 180°. However, if it is necessary to reduce the heat exchange, e.g., as a function of the thickness of the product to be annealed, it is possible to vary the angle at which the strip embraces the roller 15, increasing said angle to exchange more heat and reducing said angle to exchange less heat.

A fourth embodiment of the system of the invention comprises at least two heating zones 4, 4′, wherein at least one first heating zone provides for heating the strip by applying the solution of the first embodiment, while at least one second heating zone provides for heating the strip by applying the solution of the second or third embodiment described above.

In the non-limiting example in FIG. 8, there are provided:
a first heating zone 4, arranged upstream or in an initial position of the annealing furnace 3, where the heating solution of the first embodiment is applied;
a second heating zone 4″, arranged in a first intermediate position of the annealing furnace 3, where the heating solution of the second embodiment is applied;
a third heating zone 4′, arranged in a second intermediate position of the annealing furnace 3, where the heating solution of the first embodiment is applied again.

It is possible to provide a plurality of combinations of the heating solutions according to the first, second and third embodiments in different heating zones of the annealing furnace, also including a heating zone arranged in an end position, e.g., a final position of the furnace.

A coating process for coating a metal strip 20 advancing along the coating system described above is disclosed below.

In all embodiments of the invention, the process comprises the following stages:
annealing the metal strip 20 in the annealing furnace 3,
coating the metal strip 20 with a layer of molten metal by immersion in the pot 2; wherein there is provided a preheating of the metal strip 20 in at least one heating zone 4, arranged upstream of the annealing furnace 3, and/or a further heating of the metal strip 20 in at least one heating zone 4′ arranged in an intermediate position or end position of said annealing furnace 3;
wherein the first heat-transfer fluid conveys the heat recovered from the solar plant 5 towards the at least one heating zone 4, 4′ through the at least one first conduit 6, 6′;
wherein the at least one heat exchanger 15, 7, 7′ cooperating with the at least one first conduit 6, 6′ recovers heat from the first heat-transfer fluid for carrying out said preheating or said further heating in the at least one heating zone 4, 4′.

In a first embodiment of the process, a second heat-transfer fluid is carried by at least one second conduit 8, 8′ crossing said at least one heating zone 4, 4′, said second heat-transfer fluid being heated by recovering heat from said first heat-transfer fluid by means of the at least one heat exchanger 7, 7′ before crossing the at least one heating zone 4, 4′.

The preheating or further heating is carried out by convection, by means of at least one dispensing device 9 arranged inside the at least one heating zone 4, 4′ and connected to said at least one second conduit 8, 8′, by dispensing the second heat-transfer fluid onto the metal strip passing into at least one passage area of said at least one heating zone 4, 4′.

In a second embodiment of the process, the at least one heat exchanger comprises, or consists of, a plurality of rollers 15, e.g., bridle rollers, arranged inside the at least one heating zone 4, 4′ for advancing the metal strip 20, and the heating of the metal strip 20 occurs by conduction by a direct or indirect cooperation of said rollers 15 with the at least one first conduit 6, 6′.

In a first variant of said second embodiment of the process, the rollers 15 are provided with at least one inner channel.

As the rollers 15 are interposed between an initial stretch and a final stretch of said at least one first conduit 6, 6′ and the respective at least one inner channel communicates with said initial stretch and said end stretch, the first heat-transfer fluid, passing into the at least one first conduit 6, 6′, crosses the at least one inner channel provided in each of the rollers 15 for heating the metal strip by conduction.

In a second variant of said second embodiment of the process, wherein the rollers 15 are provided with at least one inner channel, a second heat-transfer fluid is carried by at least one second conduit 8, 8′ crossing the at least one heating zone 4, 4′; and said second heat-transfer fluid is heated, before crossing the at least one heating zone, by recovering heat from the first heat-transfer fluid by means of a further heat exchanger 7, 7′ cooperating with the at least one first conduit 6, 6′ and the at least one second conduit 8, 8′.

As the rollers 15 are interposed between a first stretch and a second stretch of said at least one second conduit 8, 8′ and the respective at least one inner channel communicates with said first stretch and said second stretch, the inner channels of the rollers 15 are crossed by the second heat-transfer fluid for heating the metal strip by conduction.

Preferably, in all embodiments, the first heat-transfer fluid at a low temperature, stored in the first tank 10, is heated by crossing at least one tubing 12 running through the field 13 provided with a plurality of, preferably movable, mirrors 14 which reflect the solar radiation towards said at least one tubing 12, producing a first heat-transfer fluid at a high temperature, which is stored in the second tank 11. The at least one tubing 12 connects the first tank 10 to the second tank 11.

Part of the first heat-transfer fluid at a high temperature passes from the second tank 11 into the at least one first conduit 6, 6′ to cooperate with the at least one heat exchanger 15, 7, 7′, said at least one first conduit 6, 6′ connecting the second tank 11 to the first tank 10.

Where necessary, there is provided maintaining the temperature of the first heat-transfer fluid in a range of stable use inside the first tank 10, the at least one tubing 12, the second tank 11, and the at least one first conduit 6, 6′.

In a first variant of the process of the invention, the first heat-transfer fluid consists of diathermic oils, while the second heat-transfer fluid consists of inert gas, preferably diluted in hydrogen, to perform a reducing action on the metal strip.

The diathermic oil is used both for storing in the storage tanks 10 and 11 and as a transport means for the heat inside the solar field 13.

Thermal storage is carried out by enthalpy, the diathermic oil reaching high temperatures in the liquid state.

The maximum temperature of use of the diathermic oil is preferably of about 340-390 °C.

Among the advantages of using diathermic oil there are:
outstanding performance at high temperature, including excellent thermal stability and low vapor pressure;
constant and reliable performance for transferring heat for long periods of time;
it provides an even, reliable, efficient process heat, without requiring high pressures;
the high boiling point contributes to reducing volatility and problems of fluid loss associated with other fluids;
it is not corrosive for the metals commonly used in the construction of heat-transfer systems.

Examples of diathermic oils particularly suitable for being used in the system of the invention are the products commercially known as Therminol, preferably Therminol products from 55 to 75, e.g., Therminol 66.

In a second variant of the process of the invention, the first heat-transfer fluid consists of molten salts, while the second heat-transfer fluid consists of inert gas, preferably diluted in hydrogen to perform a reducing function on the metal strip.

The molten salts are used both for storing in the storage tanks 10 and 11 and as a transport means for the heat inside the solar field 13.

Thermal storage is carried out by enthalpy, the molten salts reaching high temperatures in the liquid state.

Among the advantages of using molten salts there are:
the liquid state thereof at low pressures and high temperatures, unlike water, for example, which reaches high pressures at high temperatures;
a lower specific heat than water while allowing a greater storage of energy;
the storage tanks for the molten salts are very similar to those for water;
in the case of losses, since there are no high pressures, the use thereof is not dangerous despite being a combustion agent.

In a first example of said first variant, the first heat-transfer fluid is a binary mixture consisting of potassium nitrate KNO₃ and sodium nitrate NaNO₃. The eutectic mixture (NaNO₃—KNO₃ 60%-40%) melts at about 230 °C and has a range of stable use between 280 °C and 530-550 °C.

In a second example of said first variant, the first heat-transfer fluid is a ternary mixture consisting of potassium nitrate KNO₃, sodium nitrate NaNO₃ and potassium nitrite KNO₂, or a ternary mixture consisting of potassium nitrate KNO₃, sodium nitrate NaNO₃ and calcium nitrate CaNO₃.

Both ternary mixtures are characterized by a lower melting temperature than the aforesaid binary mixture, about 130 °C, and have a range of stable use between 180 °C and 530 °C.

The use of the ternary mixture containing calcium nitrate is preferable because potassium nitrite is a potentially carcinogenic substance.

In both examples the mixture of molten salts must be kept inside the respective range of stable use.

The range of stable use is the temperature range in which the mixture is not at risk of solidifying (lower end) and in which there are no degradation phenomena (upper end).

Degradation phenomena mean the reactions by means of which the nitrates turn into nitrites with the consequent release of oxygen. The release of oxygen is a hazard because it increases pressure in the circuits and generates serious risks of fire and/or explosion.

Normally, as mentioned above, the binary mixture is considered safe, in terms of stability, up to 550 °C, whereas for the ternary mixtures a slightly lower value is considered (530 °C), although some studies show values similar to those of the binary mixture for ternary mixtures devoid of impurities.

At the lower end of the range of stable use it is necessary for the possible second heat-transfer fluid, which will remove heat from the mixture of molten salts used as the first heat-transfer fluid, to come into contact with the salts at a relatively high temperature so as not to have areas in the heat exchanger 7, 7′ in which the salts tend to solidify.

It is also necessary to control, in a known manner, the flow rates of the two heat-transfer fluids in order to adjust the temperatures thereof.

At the upper end of the range of stable use, in addition to controlling the flow rate of the mixture of salts, for a safe process it is instead necessary to manage the flow of thermal energy supplied to the mixture of salts crossing the tubing 12 and, if necessary, interrupt said flow in the case of an excessive increase in temperature.

In the case of the solar concentration plant 5, this last operation can be carried out in a simple manner by “defocusing” the movable mirrors 14, i.e., moving the mirrors 14 so as to direct the solar rays to a different point from the tubing 12 crossed by the mixture of molten salts.

Preferably, in the case of binary mixtures of molten salts as the first heat-transfer fluid, the temperature thereof is kept in a range between 280 °C and 550 °C, optionally between 280 °C and 530 °C; while in the case of ternary mixtures of molten salts as the first heat-transfer fluid, the temperature thereof is kept in a range between 180 °C and 530 °C.

It is however possible to use other heat-transfer fluids inside the system of the invention, such as molten metals, e.g., aluminum and silicon, or fluids such as supercritical CO₂.

1. A metal strip coating system for coating a metal strip with a layer of molten metal, comprising:
a pot containing a molten metal bath;
an annealing furnace, arranged upstream of said pot, for annealing a metal strip advancing towards said pot;
at least one heating zone, arranged upstream of said annealing furnace for preheating the metal strip and/or in an intermediate position or end position of said annealing furnace for further heating said metal strip;
a solar plant for recovering heat from solar radiation by means of a first heat-transfer fluid;
at least one first conduit adapted to carry the first heat-transfer fluid to convey said heat from said solar plant towards the at least one heating zone;
at least one heat exchanger cooperating with said at least one first conduit (6, 6′) for recovering heat from said first heat-transfer fluid and heating the metal strip in said at least one heating zone.

2. The system according to claim 1, wherein said solar plant is a solar concentration plant.

3. The system according to claim 2, wherein said solar concentration plant comprises:
a field provided with a plurality of mirrors for reflecting the solar radiation;
a first tank for storing the first heat-transfer fluid at a low temperature;
a second tank for storing the first heat-transfer fluid at a high temperature;
at least one tubing connecting said first tank to said second tank by crossing said field;
wherein said mirrors are configured to reflect the solar radiation towards said at least one tubing.

4. The system according to claim 1, wherein said at least one heat exchanger comprises a plurality of rollers arranged inside said at least one heating zone for advancing the metal strip and cooperating directly or indirectly with said at least one first conduit.

5. The system according to claim 1, wherein said at least one heat exchanger comprises a plurality of rollers arranged inside said at least one heating zone for advancing the metal strip, each of said rollers being provided with at least one inner channel formed so that the rollers can be crossed by said first heat-transfer fluid for heating the metal strip by conduction, preferably said at least one first conduit crossing said at least one heating zone.

6. The system according to claim 5, wherein said rollers are interposed between an initial stretch and a final stretch of said at least one first conduit and the respective at least one inner channel communicates with said at least one first conduit so as to be crossed by said first heat-transfer fluid and heat the metal strip by conduction;
preferably wherein the inner channels of the rollers are connected in parallel and communicating at ends thereof with the initial stretch and the final stretch of said at least one first conduit; or wherein said inner channels of the rollers are connected in series by means of intermediate stretches of said at least one first conduit.

7. The system according to claim 1, wherein said at least one heat exchanger comprises a plurality of rollers arranged inside said at least one heating zone for advancing the metal strip, each of said rollers being provided with at least one inner channel;
wherein at least one second conduit is provided, adapted to carry a second heat-transfer fluid and crossing said at least one heating zone;
wherein said at least one heat exchanger comprises a further heat exchanger cooperating with said at least one first conduit and said at least one second conduit so that said second heat-transfer fluid is heated by recovering heat from said first heat-transfer fluid;
and wherein said at least one inner channel is formed so that the rollers can be crossed by said second heat-transfer fluid for heating the metal strip by conduction;
preferably wherein said rollers are interposed between a first stretch and a second stretch of said at least one second conduit and the respective at least one inner channel communicates with said first stretch and said second stretch so as to be crossed by said second heat-transfer fluid for heating the metal strip by conduction;
preferably wherein the inner channels of the rollers are connected in parallel and communicating at ends thereof with the first stretch and the second stretch of said at least one second conduit or wherein said inner channels of the rollers are connected in series by means of intermediate stretches of said at least one second conduit.

8. The system according to claim 5, wherein said solar plant is a solar concentration plant comprising:
a field provided with a plurality of mirrors for reflecting the solar radiation;
a first tank for storing the first heat-transfer fluid at a low temperature;
a second tank for storing the first heat-transfer fluid at a high temperature;
at least one tubing connecting said first tank to said second tank by crossing said field;
wherein said mirrors are configured to reflect the solar radiation towards said at least one tubing;
wherein said at least one first conduit connects said second tank to said first tank; wherein a first circuit comprises the first tank, the at least one tubing, and the second tank and a second circuit comprises the second tank the at least one first conduit, said at least one inner channel of the rollers or the further heat exchanger, and the first tank,
and wherein actuation means for actuating said first circuit and said second circuit together or separately are provided.

9. The system according to claim 1, wherein at least one second conduit is provided, adapted to carry a second heat-transfer fluid and crossing said at least one heating zone;
wherein said at least one heat exchanger cooperates with said at least one first conduit and said at least one second conduit so that said second heat-transfer fluid is heated by recovering heat from said first heat-transfer fluid;
and wherein at least one dispensing device is provided, arranged inside the at least one heating zone connected to said at least one second conduit and adapted to dispense said second heat-transfer fluid towards at least one passage area of the metal strip into said at least one heating zone for heating said metal strip by convection.

10. The system according to claim 9, wherein said solar plant is a solar concentration plant comprising:
a field provided with a plurality of mirrors for reflecting the solar radiation;
a first tank for storing the first heat-transfer fluid at a low temperature;
a second tank for storing the first heat-transfer fluid at a high temperature;
at least one tubing connecting said first tank to said second tank by crossing said field;
wherein said mirrors are configured to reflect the solar radiation towards said at least one tubing;
wherein said at least one first conduit connects said second tank to said first tank by crossing said at least one heat exchanger, and wherein a first circuit comprises the first tank the at least one tubing, and the second tank, and a second circuit comprises the second tank, the at least one first conduit, the at least one heat exchanger, and the first tank,
and wherein actuation means for actuating said first circuit and said second circuit together or separately are provided.

11. The system according to claim 9, wherein said at least one heat exchanger is arranged outside the at least one heating zone.

12. The system according to claim 3, wherein said first tank, said at least one tubing, said second tank, and said at least one first conduit have walls provided with temperature maintaining devices for maintaining a temperature of the first heat-transfer fluid;
preferably wherein said temperature maintaining devices comprise electrical resistors or inductors or tubes of water overheated by means of recovery heat.

13. A process of coating metal strips for coating a metal strip advancing along a coating system according to claim 1, comprising the following stages:
annealing the metal strip in the annealing furnace,
coating the metal strip with a layer of molten metal by immersion in said pot;
wherein there is provided a preheating of the metal strip in at least one heating zone, arranged upstream of said annealing furnace, and/or a further heating of the metal strip in at least one heating zone arranged in an intermediate position or end position of said annealing furnace;
wherein the first heat-transfer fluid conveys the heat recovered from said solar plant towards the at least one heating zone through the at least one first conduit;
wherein the at least one heat exchanger cooperating with said at least one first conduit recovers heat from said first heat-transfer fluid for carrying out said preheating or said further heating in the at least one heating zone.

14. The A process according to claim 13, wherein said at least one heat exchanger comprises a plurality of rollers arranged inside said at least one heating zone for advancing the metal strip, and wherein the heating of the metal strip occurs by conduction by direct or indirect cooperation of said rollers with said at least one first conduit.

15. The process according to claim 14, wherein said first heat-transfer fluid, passing into the at least one first conduit, crosses at least one inner channel provided in each of the rollers by heating the metal strip by conduction.

16. The process according to claim 14, wherein each of said rollers is provided with at least one inner channel;
wherein a second heat-transfer fluid is carried by at least one second conduit crossing the at least one heating zone, and said second heat-transfer fluid is heated, before crossing the at least one heating zone, by recovering heat from the first heat-transfer fluid by means of a further heat exchanger cooperating with the at least one first conduit and the at least one second conduit;
wherein said second heat-transfer fluid crosses the at least one inner channel of each of the rollers by heating the metal strip by conduction.

17. The process according to claim 14, wherein a second heat-transfer fluid is carried by at least one second conduit crossing said at least one heating zone, said second heat-transfer fluid being heated by recovering heat from said first heat-transfer fluid by means of the at least one heat exchanger before crossing the at least one heating zone;
and wherein said preheating or said further heating is carried out by convection, by means of at least one dispensing device arranged inside the at least one heating zone and connected to said at least one second conduit, by dispensing the second heat-transfer fluid onto the metal strip passing into at least one passage area of said at least one heating zone.

18. The process according to claim 13, wherein the first heat-transfer fluid at a low temperature, stored in a first tank, is heated by crossing at least one tubing running through a field provided with a plurality of mirrors which reflect the solar radiation towards said at least one tubing, producing a first heat-transfer fluid at a high temperature which is stored in a second tank, said at least one tubing connecting the first tank to the second tank;
and wherein part of said first heat-transfer fluid at a high temperature passes into said at least one first conduit to cooperate with said at least one heat exchanger, said at least one first conduit connecting the second tank to the first tank.

19. The system according to claim 7, wherein said solar plant is a solar concentration plant comprising:
a field provided with a plurality of mirrors for reflecting the solar radiation;
a first tank for storing the first heat-transfer fluid at a low temperature;
a second tank for storing the first heat-transfer fluid at a high temperature;
at least one tubing connecting said first tank to said second tank by crossing said field;
wherein said mirrors are configured to reflect the solar radiation towards said at least one tubing;
wherein said at least one first conduit connects said second tank to said first tank; wherein a first circuit comprises the first tank, the at least one tubing, and the second tank, and a second circuit comprises the second tank, the at least one first conduit, said at least one inner channel of the rollers or the further heat exchanger, and the first tank,
and wherein actuation means for actuating said first circuit and said second circuit together or separately are provided.

20. The system according to claim 10, wherein said first tank, said at least one tubing, said second tank, and said at least one first conduit have walls provided with temperature maintaining devices for maintaining a temperature of the first heat-transfer fluid;
preferably wherein said temperature maintaining devices comprise electrical resistors or inductors or tubes of water overheated by means of recovery heat.
